(19) United States
(12) Patent Application Publication
(10) Pub. No.: US 2014/0334140 A1
(43) Pub. Date: Nov. 13, 2014

(54) COMBINED LIGHT EMITTING DEVICE

(71) Applicant: ADO OPTRONICS CORPORATION, Bade City (TW)

(72) Inventor: Hua Jung CHIU, Bade City (TW)

(21) Appl. No.: 13/901,153

(22) Filed: May 23, 2013

(30) Foreign Application Priority Data
May 8, 2013 (TW) 102208536

(51) Int. Cl. F21V 19/00

(52) U.S. Cl. CPC F21V 19/001
USPC 362/217.17

(57) ABSTRACT

A combined light emitting device includes: a multi-way connection tube and a light emitting member. The multi-way connection tube is provided with a plurality of sub-tubes which are connected at one jointing point, and each of the sub-tubes has a connecting portion within the sub-tube. A light emitting member is coupling connected to one or more connecting portions of the sub-tubes. The connecting portion of the sub-tube without combining with any light emitting member is coupled to an attaching member, the attaching member is coupled with a connecting portion of another multi-way connection tube or is coupled with an extension member to combine the multi-way connection tube with another multi-way connection tube or with the extension member.

### CROSS-REFERENCE TO RELATED APPLICATION

This application claims priority to Taiwanese Patent Application No. 102208536, filed May 8, 2013, which is hereby incorporated by reference.

### FIELD OF THE INVENTION

The present invention relates to a lamp for lighting and for decoration, and more particularly to a combined light emitting device.

### BACKGROUND OF THE INVENTION

Lamps are usually used for lighting or for decoration. The characteristic of the lamps for lighting are being focused on the arrangement of light source, such as the placement of light sources, the position of light sources, the emitting direction of light sources, and so on, to provide a suitable surrounding illumination. The lamps for decoration, on the contrary, are characterized by the collocation between a holder and the light sources to thus create a specific atmosphere by the design of the holder ornamented with the light sources.

In a prior art, conventional lamps always possesses with a fixed-type of position location for the light source and the holder during a design phase prior to production, and therefore a resulted made-up lamp always has a unchangeable configuration. Beside, with the increase of the number of the light source or of the complexity of the holder, the lamp will occupy more and more space due to its increasing in size and it will be inconvenient for package, storage, and demonstration. Further, a special lamp with a very unique external shape is usually expensive since it only attracts only very few people and it becomes only suitable for a small amount production.

### SUMMARY OF THE INVENTION

Accordingly, it is an aspect of the present invention to provide a combined light emitting device capable of combining to various configurations to satisfy different users.

Further, another aspect of the present invention is to provide a light emitting device suitable for a mass production to reduce cost.

The present invention thus provides a combined light emitting device, comprising: a multi-way connection tube provided with a plurality of sub-tubes which are connected at one jointing point, each of the sub-tubes having a connecting portion within the sub-tube; and a light emitting member coupled to one or more connecting portions of the sub-tubes to emit light from inside of the sub-tube toward outside of the sub-tube, wherein the connecting portion of the sub-tube without combining with the light emitting member is coupled to an attaching member, the attaching member is coupled with a connecting portion of another multi-way connection tube or is coupled with an extension member to combine the multi-way connection with another multi-way connection tube or with the extension member.

According to an embodiment of the present invention, the connecting portion is spaced apart from an orifice of the sub-tube with a receiving space.

According to an embodiment of the present invention, the connecting portion is a receiving flange.

According to an embodiment of the present invention, the connecting portion is a fastening hole.

According to an embodiment of the present invention, the multi-way connection tube is provided at a tube wall thereof with a fastening opening.

According to an embodiment of the present invention, the light emitting member includes a receiving part and a lighting source, the receiving part is for coupling to the connecting portion and for receiving the lighting source.

According to an embodiment of the present invention, the light emitting member includes a light cover fitted in the receiving part for covering the lighting source.

According to an embodiment of the present invention, the attaching member has a through hole communicated between the sub-tube and another multi-way connection tube or between the sub-tube and the extension member.

According to an embodiment of the present invention, the attaching member includes two male-female adapters and a dual-male adapter, each of the male-female adapters has a male coupler and a female coupler, the dual-male adapter has two male fasteners, the two male couplers of the male-female adapter are coupled respectively to the connecting portion of the multi-way connection tube and the connecting portion of another multi-way connection tube, and either one of the male fastener of the dual-male adapter is fastened to the female couplers of the male-female adapter.

According to an embodiment of the present invention, wherein the attaching member includes a male-female adapter and a single-male adapter, the male-female adapter has a male coupler and a female coupler, the single-male adapter has a male fastener and an adaptive fastener, the male coupler of the male-female adapter is coupled to the connecting portion, the male fastener of the single-male adapter is fastened to the female coupler of the male-female adapter, and the adaptive fastener of the single-male adapter is fastened to the extension member.

By means of technical means of the present invention, users are allowed to optionally choose and combine different multi-way connection tube with different extension member to obtain a combined light emitting device having a desired configuration for lighting or for decoration. Further, the combined light emitting device of the present invention is constructed of several modularized members, such as the multi-way connection tube, the light emitting member, the attaching member, and the extension member. And these modularized members are suitable for a mass production to thus effectively reduce cost.

### BRIEF DESCRIPTION OF THE DRAWINGS

The structure and the technical means adopted by the present invention to achieve the above and other objects can be best understood by referring to the following detailed description of the preferred embodiments and the accompanying drawings.

FIG. 1 is a stereogram of a combined light emitting device of an embodiment according to the present invention;

FIG. 2 is a cross-section view of the combined light emitting device of FIG. 1.

FIGS. 3a-3e are stereogram of multi-way connection tubes of other embodiments according to the present invention;

FIG. 4 is a stereogram of a combined light emitting device of another embodiment according to the present invention;

FIG. 5 is an explosion diagram of the combined light emitting device of FIG. 4;

FIG. 6 is a stereogram of a combined light emitting device of another embodiment according to the present invention; and

FIG. 7 is a stereogram of a combined light emitting device of another embodiment according to the present invention.

### DETAILED DESCRIPTION OF THE PREFERRED EMBODIMENTS

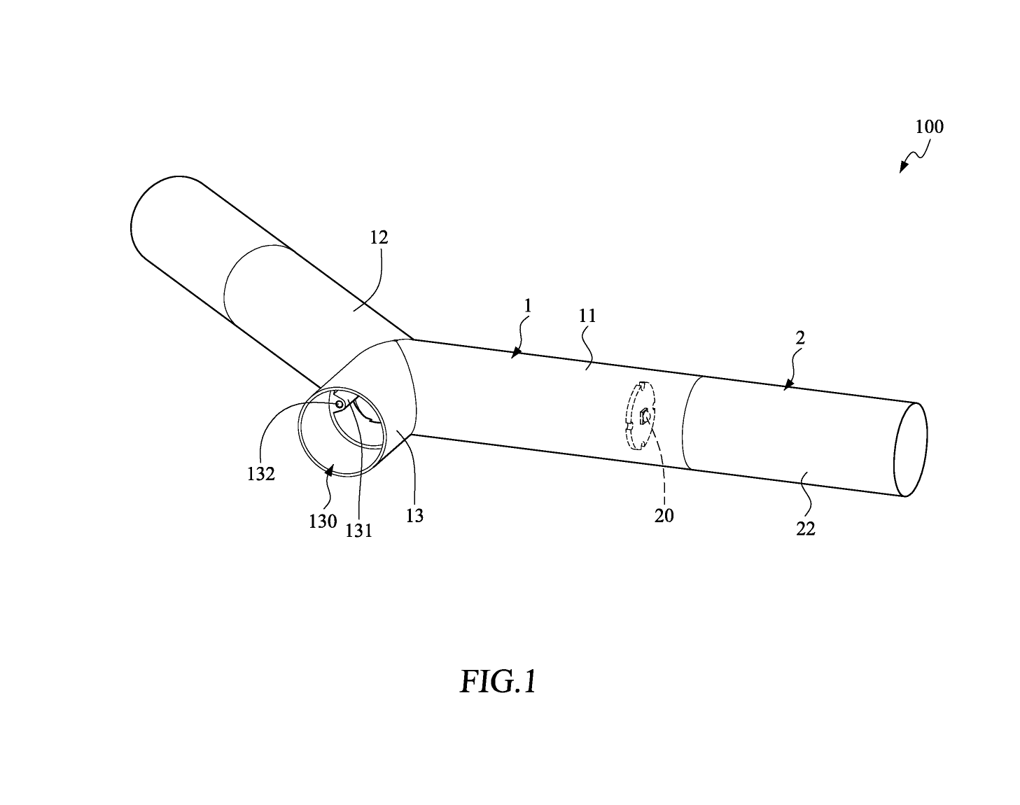

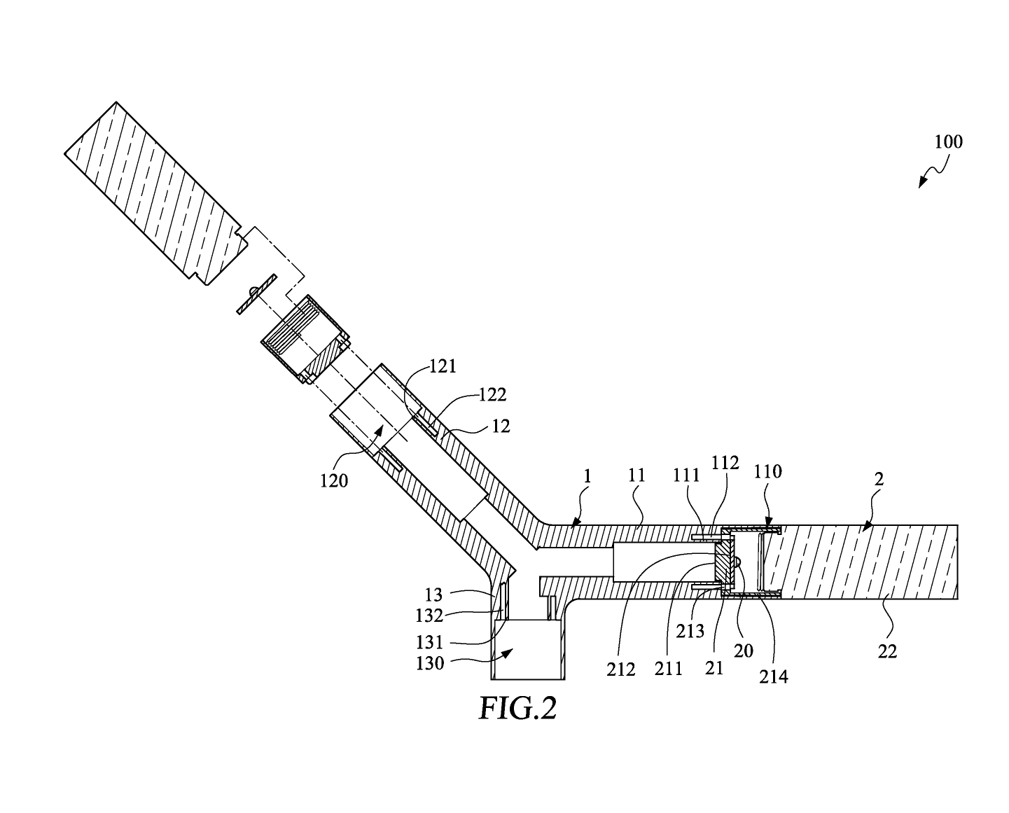

Please refer to FIGS. 1 and 2, a combined light emitting device 100 of an embodiment according to the present invention includes a multi-way connection 1 and light emitting members 2.

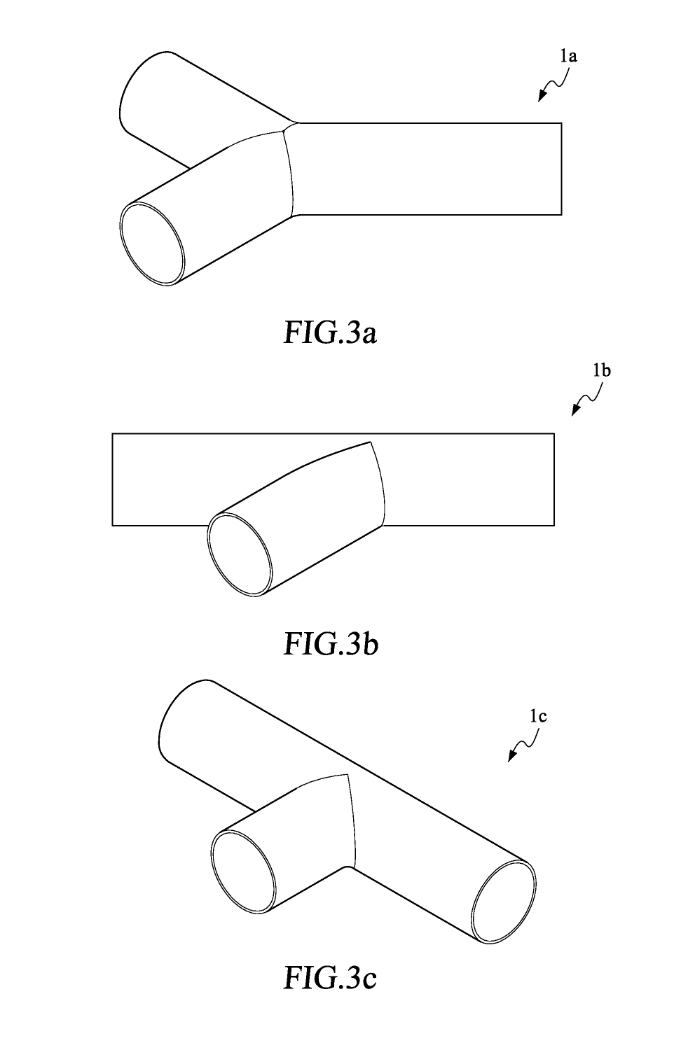

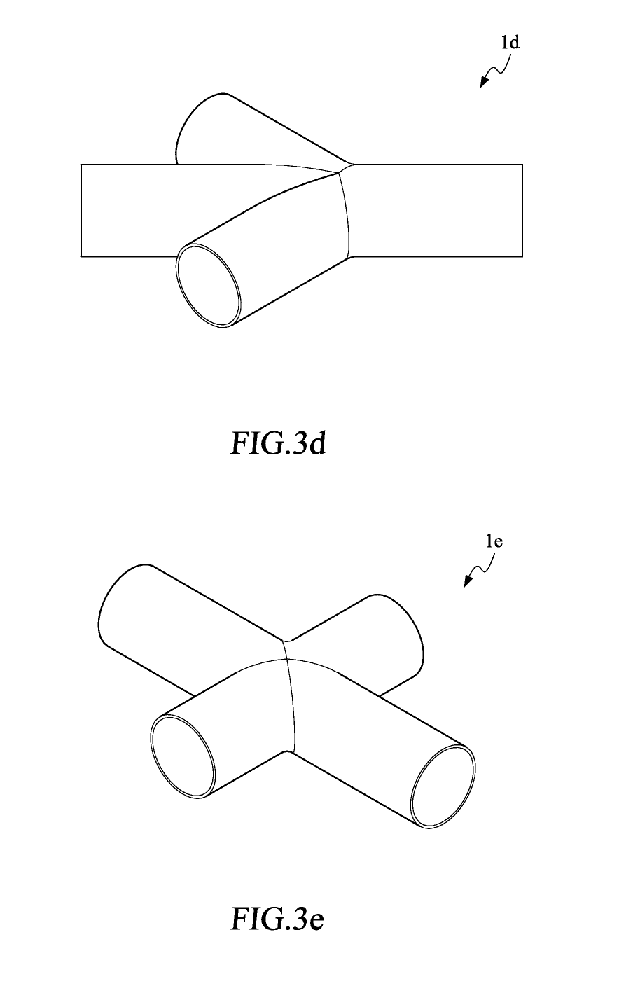

The multi-way connection tube 1 is provided with a plurality of sub-tubes which are connected at one jointing point. In this embodiment, the multi-way connection tube 1 is a three-way connection tube in which three sub-tubes 11, 12, and 13 are provided. In other variations, the multi-way connection tube may be provided with two, four, or more sub-tubes, and these sub-tubes may be arranged in any orientation to form various configurations of the multi-way connection tube such as multi-way connection tubes 1a, 1b, 1c, 1d, and 1e as the examples in FIGS. 3a-3e. One sub-tube has at least one connecting portion within the sub-tube. In an embodiment, each of the sub-tubes 11, 12, and 13 has two connecting portions 111, 112, 121, 121, 131, and 132. The connecting portions 111, 121, and 131 are receiving flanges being protruded from an internal surface of the sub-tubes 11, 12, and 13. The connecting portions 1112, 122, and 132 are fastening holes. Preferably, the connecting portions 111, 112, 121, 121, 131, and 132 are spaced apart from a corresponding orifice of the sub-tubes 11, 12, and 13 respectively with a receiving space 110, 120, and 130 for receiving the light emitting member 2 or an attaching member.

A light emitting member 2 is coupling connected to one of the connecting portions of the sub-tubes. In this embodiment, two light emitting members are provided to couple to the sub-tubes 11 and 12, respectively. The light emitting member includes a lighting source 20, a receiving part 21, and a light cover 22. Taking combining the light emitting member 2 and the sub-tube 11 as an example, the receiving part 21 is coupled to the connecting portions 111 and 112, the lighting source 20 is received in the receiving part 21, and the light cover 22 is fitted in the receiving part 21 and covers the lighting source 20. In other variations, the lighting source 20 may be directly coupled to the connecting portion 11 so that the receiving part 21 is not provided, and the light cover 22 also may be not provided. The lighting source 20 is preferable as a LED which is smaller in size and is lower in power consumption. The receiving part 21 is a cup shape element, where the outer side of one end thereof is formed with an inserting portion 211 which is for inserting into the sub-tube 11 and is fastened by the connecting portion 111. The receiving part 21 is also formed, at the outer side of the end, with a receiving portion 212 to receive the lighting source 20 therein. A plurality of securing holes 213 corresponding to openings of the connecting portions 121 and of the lighting source 20 are formed around the receiving portion 212. And these three holes are secured by a screw that is provided to pass through these three holes. A sleeve portion 214, which is formed extending from a side of the receiving portion 212, is fitted within the receiving space 110 of the sub-tube 11. The light cover 22 is a cylinder transparent to light and is form at an end thereof with an outer thread screwed to an inner thread of the sleeve portion 214, where the inner thread 214 is formed on an internal surface of the sleeve portion 214. The light emitting member 2 is also combined with the sub-tube 12 in the same way as that combined with the sub-tube 11, and therefore these detail descriptions the same as that of the light emitting member 2 and the sub-tube 11 is combined are thus omitted here.

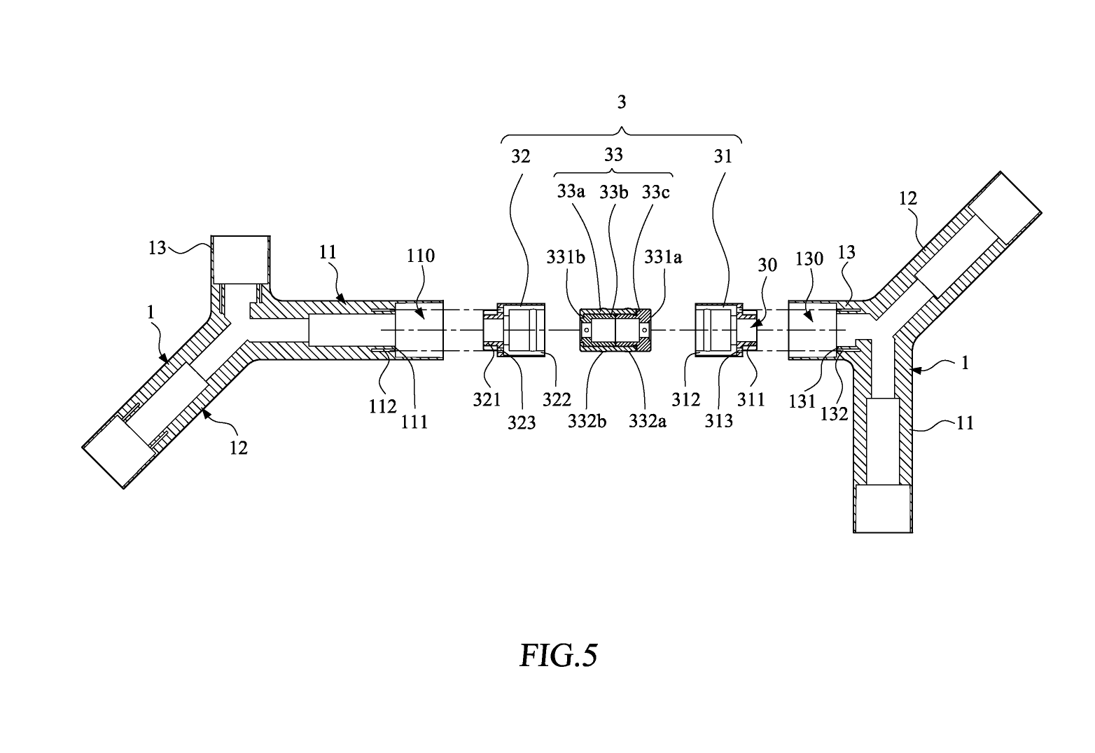

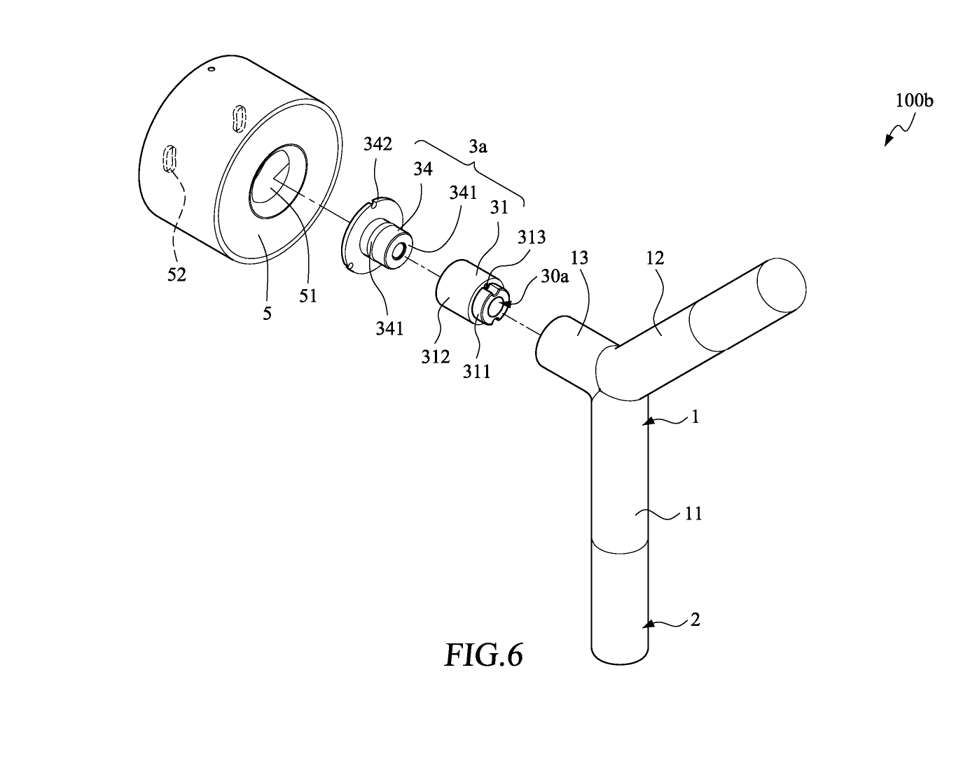

In the combined light emitting device 100, the connecting portions 131 and 132 of the sub-tube 13 without combining with any light emitting member 2 may be coupled to an attaching member to couple with a connecting portion of another multi-way connection tube (see FIG. 5) or to couple with an extension member (see FIG. 6) in such a manner that the multi-way connection tube 1 is combined with another multi-way connection tube or is combined with the extension member. The details thereof are described as follow.

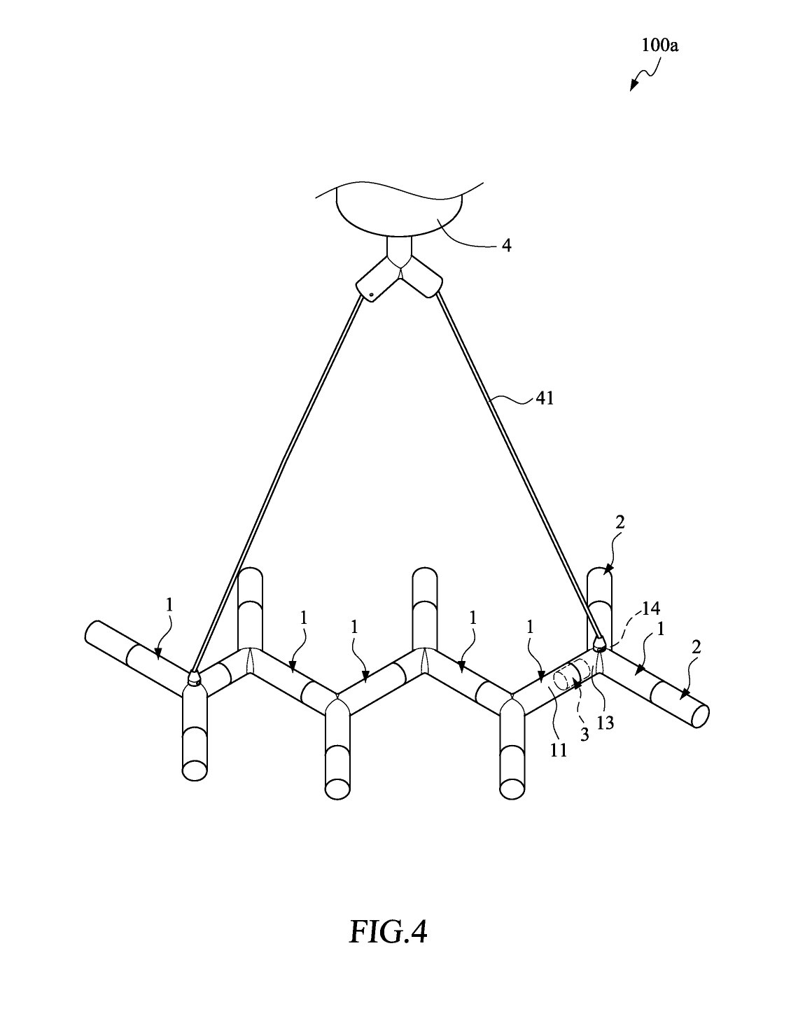

In an embodiment of FIGS. 4 and 5, a combined light emitting device 100a includes a plurality of multi-way connection tubes 1 that are combined with each other, in which every two multi-way connection tubes 1 are combined by an attaching member 3. The attaching member 3 includes two male-female adapters 31 and 32 and a dual-male adapter 33. The male-female adapter 31 has a male coupler 311 and a female coupler 312, the male-female adapter 32 has a male coupler 321 and a female coupler 322, and the dual-male adapter 33 has two male fasteners 331a and 331b. The male coupler 311 of the male-female adapter 31 is coupled to the connecting portions 131 and 132 of the sub-tube 13 of the multi-way connection tube 1, and the female coupler 312 of the male-female adapter 31 is fastened to the male fastener 331 a of the dual-male adapter 33. The male coupler 321 of the male-female adapter 32 is coupled to the connecting portions 111 and 112 of the sub-tube 11 of another multi-way connection tube 1, and the female coupler 322 of the male-female adapter 32 is fastened to the male fastener 331b of the dual-male adapter 33. The two multi-way connection tubes 1 are thus combined with each other.

In a specific structure, the male couplers 311 and 321 of the male-female adapters 31 and 32 are protruding plugs which are respectively plugged in the sub-tubes 13 and 11 and are respectively snapped with the connecting portions (receiving flanges) 131 and 111 protruding from internal surfaces of the sub-tubes 13 and 11. Preferably, a plurality of securing holes 313 and 323 corresponding to the connecting portions 132 and 112 are respectively formed around the male couplers 311 and 321, and thereby the male couplers 311 and 321 are respectively secured to the sub-tubes 13 and 11 by a screw, where the screw is provided to pass through them. The dual-male adapter 33 is further provided on external surfaces of the male fasteners 331 a and 331 b with annular flanges 332a and 332b, respectively. The annular flanges 332a and 332b are provided to hold an internal surface of the male couplers 311 and 321 to firmly connect the dual-male adapter 33 and male-female adapters 31 and to firmly connect the dual-male adapter 33 and male-female adapters 32, respectively. The dual-male adapter 33 is constructed of three parts 33a, 33b, and 33c in this embodiment, but it may a whole single part or any numbers of parts. In one embodiment, the male-female adapters 31 and 32 are coupled to the corresponding sub-tubes 13 and 11, and then the dual-male adapter 33 is coupled to the two male-female adapters 31 and 32. The two multi-way connection tubes 1 are thus combined with each other. Preferably, the attaching member 3 may have a through hole 30, where the through hole 30 is provided for communicating the sub-tube 13 with another multi-way connection tube 1, and electric cords of the light emitting members 2 passes through the through hole 30.

In this embodiment, the multi-way connection tubes 1 are combined to form a holder of the combined light emitting device 100a, and the light emitting members 2 are provided on several sub-tubes located at the extension end. In addition, in FIG. 4, some of the multi-way connection tubes 1 are further provided at a tube wall thereof with a fastening opening 14 to allow the passage of a rope 41 of a hanging member 4 for fastening purpose, and thus the combined light emitting device 100a is used as a ceiling lamp.

Please refer to FIG. 6, in which a combined light emitting device 100b used as a wall lamp is shown. In this embodiment, a multi-way connection tube 1 of the combined light emitting device 100b is coupled to an attaching member 3a, where the attaching member 3a is coupled with an extension member 5 in such a manner that the multi-way connection tube 1 is combined with the extension member 5. The attaching member 3a includes a male-female adapter 31 and a single-male adapter 34. The structure of the male-female adapter 31 is the same as that of the embodiment mentioned above, and thus the detail description for the male-female adapter 31 is omitted here. The single-male adapter 34 has a male fastener 341 and an adaptive fastener 342. The male coupler 311 of the male-female adapter 31 is coupled to the connecting portions 131 and 132 of the sub-tube 13, the female coupler 312 of the male-female adapter 31 is fastened to the male fastener 341 of the single-male adapter 34, and the adaptive fastener 342 of the single-male adapter 34 is fastened to the extension member 5. Further, the single-male adapter 34 is further provided on an external surface of the male fasteners 341 thereof with an annular flange 341a. The annular flange 341a is provided to hold an internal surface of the male couplers 312 to firmly connect the single-male adapter 34 and male-female adapters 31. The adaptive fastener 342 of the single-male adapter 34 is a fastening rib which extends from the external surface of the single-male adapter 34 and has a cross-sectional area that is large enough to prevent it loosening from a fastened opening 51 of the extension member 5. In addition, the attaching member 3a has a through hole 30a communicated between the sub-tube 13 and the extension member 5 for passing electric cords of the light emitting members 2 therethrough. The extension member 5 is a wall mount provided with several mounting openings for mounting on a wall (not shown), and thus the combined light emitting device 100b is used as a wall lamp.

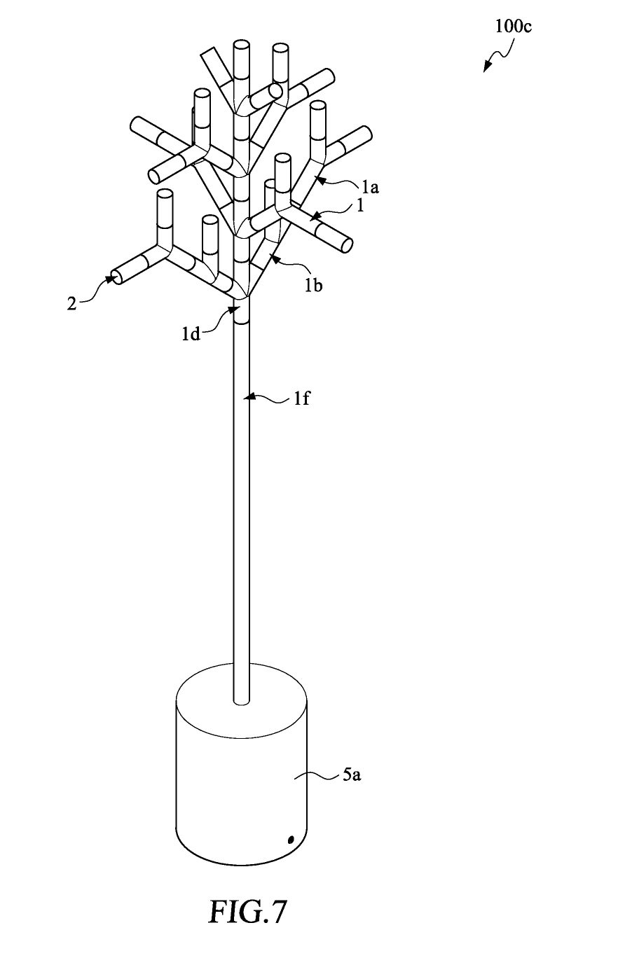

Please refer to FIG. 7, in which a combined light emitting device 100c used as a decorative lamp is shown. In this embodiment, the combined light emitting device 100c includes several multi-way connection tubes 1, 1a, 1c, 1e, and 1f in various configurations to form a tree form held by an extension member 5a used as a base element. However, the present invention is not limited to this, and therefore a user can combine different multi-way connection tube with different extension member to obtain a combined light emitting device in various configurations.

From the above, by means of the present invention, a user can combine different multi-way connection tube with different extension member to obtain a combined light emitting device having a desired configuration for lighting or for decoration. Further, the combined light emitting device of the present invention is constructed of several modularized members, such as the multi-way connection tube, the light emitting member, the attaching member, and the extension member. And these modularized members are suitable for a mass production to thus effectively reduce cost.

The above description should be considered as only the discussion of the preferred embodiments of the present invention. However, a person having ordinary skill in the art may make various modifications to the present invention. Those modifications still fall within the spirit and scope defined by the appended claims

What is claimed is:

1. A combined light emitting device, comprising:
a multi-way connection tube provided with a plurality of sub-tubes which are connected at one jointing point, each of the sub-tubes having a connecting portion within the sub-tube; and
a light emitting member coupled to one or more connecting portions of the sub-tubes to emit light from inside of the sub-tube toward outside of the sub-tube,
wherein the connecting portion of the sub-tube without combining with any light emitting member is coupled to an attaching member, the attaching member is coupled with a connecting portion of another multi-way connection tube or is coupled with an extension member to combine the multi-way connection tube with another multi-way connection tube or with the extension member.

2. The combined light emitting device as claimed in claim 1, wherein the connecting portion is spaced apart from an orifice of the sub-tube with a receiving space.

3. The combined light emitting device as claimed in claim 1, wherein the connecting portion is a receiving flange.

4. The combined light emitting device as claimed in claim 1, wherein the connecting portion is a fastening hole.

5. The combined light emitting device as claimed in claim 1, wherein the multi-way connection tube is provided at a tube wall thereof with a fastening opening.

6. The combined light emitting device as claimed in claim 1, wherein the light emitting member includes a receiving part and a lighting source, the receiving part is for coupling to the connecting portion and for receiving the lighting source.

7. The combined light emitting device as claimed in claim 6, wherein the light emitting member includes a light cover fitted in the receiving part for covering the lighting source.

8. The combined light emitting device as claimed in claim 1, wherein the attaching member has a through hole communicated between the sub-tube and another multi-way connection tube or communicated between the sub-tube and the extension member.

9. The combined light emitting device as claimed in claim 1, wherein the attaching member includes two male-female adapters and a dual-male adapter, each of the male-female adapters has a male coupler and a female coupler, the dual-male adapter has two male fasteners, the two male couplers of the male-female adapter are coupled respectively to the connecting portion of the multi-way connection tube and the connecting portion of another multi-way connection tube, and either one of the male fastener of the dual-male adapter is fastened to the female couplers of the male-female adapter.

10. The combined light emitting device as claimed in claim 1, wherein the attaching member includes a male-female adapter and a single-male adapter, the male-female adapter has a male coupler and a female coupler, the single-male adapter has a male fastener and an adaptive fastener, the male coupler of the male-female adapter is coupled to the connecting portion, the male fastener of the single-male adapter is fastened to the female coupler of the male-female adapter, and the adaptive fastener of the single-male adapter is fastened to the extension member.
